(19) United States
(12) Patent Application Publication
(10) Pub. No.: US 2011/0058556 A1
(43) Pub. Date: Mar. 10, 2011

(54) GENERIC ROUTING ENCAPSULATION BEARING METHOD, APPARATUS AND SYSTEM

(75) Inventor: Jun HE, Shenzhen (CN)

(73) Assignee: HUAWEI TECHNOLOGIES CO., LTD, Shenzhen (CN)

(21) Appl. No.: 12/944,178

(22) Filed: Nov. 11, 2010

Related U.S. Application Data
(63) Continuation of application No. PCT/CN2009/071474, filed on May 27, 2009.

(30) Foreign Application Priority Data
May 12, 2008 (CN) 200810106369.5

(51) Int. Cl. H04L 12/56

(52) U.S. Cl. 370/392

(57) ABSTRACT

A Generic Routing Encapsulation (GRE) bearing method, apparatus and system are provided. In the transmission and bearing of GRE frames, multiplexing frame header information of the GRE frames is obtained by inquiring mapping of the GRE frames; then the GRE frames that meet a predetermined multiplexing condition are set in payloads of one outer Internet Protocol (IP) frame according to the obtained multiplexing frame header information of the GRE frames. In this way, for data frames with small payloads, unnecessary encapsulation overheads are reduced, and the transmission efficiency of the data frames is improved. Thus, the network bandwidth resources are saved, and the system transmission performance is improved.

### CROSS-REFERENCE TO RELATED APPLICATIONS

This application is a continuation of International Application No. PCT/CN2009/071474, filed on Apr. 27, 2009, which claims priority to Chinese Patent Application No. 200810106369.5, filed on May 12, 2008, both of which are hereby incorporated by reference in their entireties.

### FIELD OF THE INVENTION

The present invention relates to network communications, and in particular, to a Generic Routing Encapsulation (GRE) bearing method, apparatus and system.

### BACKGROUND OF THE INVENTION

GRE is a layer 3 tunneling protocol. It specifies a method for encapsulation of one network protocol over another network protocol. The two ends of a GRE tunnel are defined by a source Internet Protocol (IP) address and a destination IP address. GRE tunnel encapsulation is used for data transmit bearing in a plurality of access networks.

For example, the Worldwide Interoperability for Microwave Access (WiMAX) standard uses GRE tunnel encapsulation for transmit bearing on the R6 interface between a Base Station (BS) and an Access Service Network Gateway (ASN-GW).

FIG. 1 is a block diagram illustrating the application of GRE tunnel encapsulation in WiMAX. The IP packets of a Mobile Station (MS) are GRE encapsulated and then transmitted over the R6 interface between the BS and the ASN-GW. Each encapsulated GRE packet includes a GRE key value that is used to identify a specific data stream in the encapsulated GRE packet. In GRE bearing, because a lot of overheads need to be added, the transmission efficiency is very low. Especially, the transmission efficiency is lower for short packets with small payloads. FIG. 2 shows a structure of a frame after GRE packet encapsulation according to the prior art. In FIG. 2, the encapsulated GRE frame includes a payload field and a GRE frame header (GRE header). If the transmission payload is relatively small, that is, if a short packet is transmitted, the transmission efficiency is very low, causing a waste of network bandwidth resources.

To sum up, the inventor finds at least the following problems in the prior art: according to the GRE bearing method in the prior art, unnecessary encapsulation overheads are added. Thus, the transmission efficiency is low and network bandwidth resources are wasted. This is even worse for data frames with relatively small payloads.

### SUMMARY OF THE INVENTION

Embodiments of the present invention provide a GRE bearing method, apparatus and system, which can improve the transmit bearing efficiency of data frames, save network bandwidth resources, and reduce unnecessary encapsulation overheads.

A GRE bearing method includes:
obtaining multiplexing frame header information of GRE frames by inquiring mapping of the GRE frames; and
setting GRE frames that meet a predetermined multiplexing condition in payloads of one outer Internet Protocol (IP) frame according to obtained multiplexing frame header information of the GRE frames.

A GRE bearing apparatus includes:
a frame header information obtaining unit, configured to obtain multiplexing frame header information of GRE frames by inquiring mapping of the GRE frames; and
a frame multiplexing unit, configured to set GRE frames that meet a predetermined multiplexing condition in payloads of one outer IP frame according to the multiplexing frame header information of the GRE frames that is obtained by the frame header information obtaining unit.

A GRE bearing system includes:
a data sender, configured to obtain multiplexing frame header information of GRE frames by inquiring mapping of the GRE frames and set GRE frames that meet a predetermined multiplexing condition in payloads of one outer IP frame according to the obtained multiplexing frame header information of the GRE frames; and
a data receiver, configured to demultiplex the multiplexed outer IP frame after receiving the outer IP frame to obtain multiple IP frames each of which includes a single GRE frame.

As seen from the foregoing technical solution, in the transmit bearing of GRE frames, multiple GRE frames that meet a predetermined multiplexing condition are set in payloads of one outer IP frame, and the frame header of the IP frame is multiplexed. In this way, for data frames with relatively small payloads, the technical solution can reduce unnecessary encapsulation overheads, improve the transmission efficiency of data frames. Therefore, network bandwidth resources are saved, and the system transmission performance is improved.

### BRIEF DESCRIPTION OF THE DRAWINGS

FIG. 1 is a block diagram illustrating the application of GRE tunnel encapsulation in WiMAX according to the prior art;

FIG. 2 shows a structure of a frame after GRE packet encapsulation according to the prior art;

FIG. 3 shows a flowchart of a GRE bearing method provided according to Embodiment 1 of the present invention;

FIG. 4 shows a structure of an outer IP frame in which GRE frames are set according to Embodiment 1 of the present invention;

FIG. 5 shows a structure of a GRE frame in which the payloads of multiple GRE frames are set according to Embodiment 1 of the present invention;

FIG. 6 shows a structure of a GRE bearing apparatus provided according to Embodiment 2 of the present invention; and

FIG. 7 shows a structure of a GRE bearing system provided according to Embodiment 3 of the present invention.

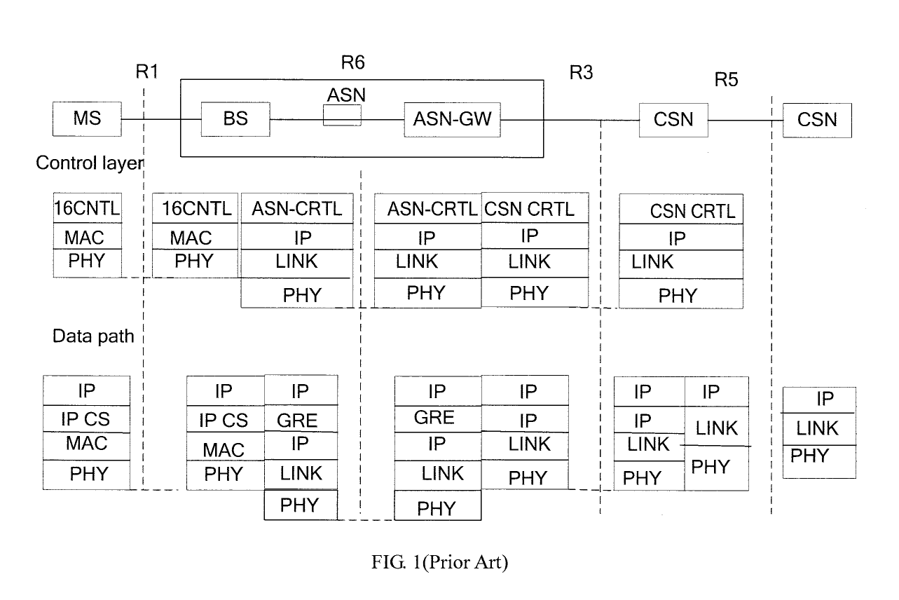

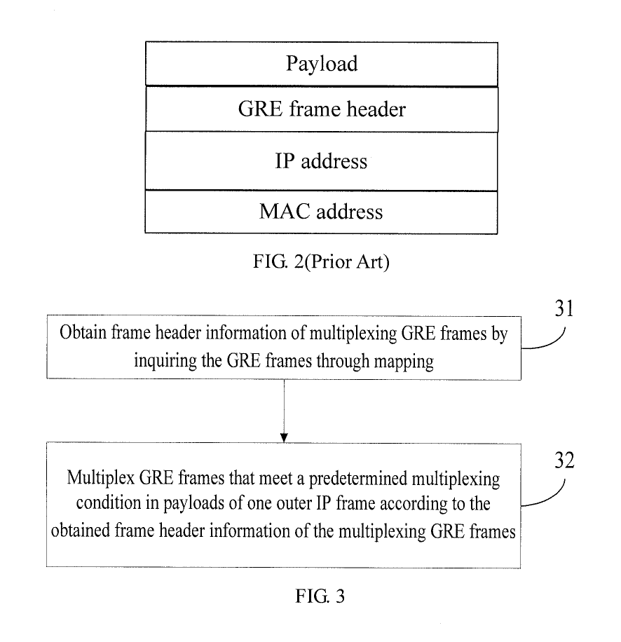

### DETAILED DESCRIPTION OF THE EMBODIMENTS

Embodiments of the present invention provide a GRE bearing method, apparatus and system. In the transmission of GRE frames, the GRE frame header or outer IP frame header is multiplexed according to a predetermined multiplexing condition. In this way, multiple data frames with small payloads are combined for transmission and bearing, which can reduce unnecessary encapsulation overheads and improve the transmission efficiency of data frames. Therefore, network bandwidth resources are saved, and the system transmission performance is improved.

The embodiments of the present invention are hereinafter described in detail with reference to the accompanying drawings. FIG. 3 shows a flowchart of a GRE bearing method provided according to Embodiment 1 of the present invention. The bearing method includes the following steps:

Step 31: Obtain multiplexing frame header information of GRE frames by inquiring mapping of the GRE frames.

Specifically, in the process of selecting GRE frames, the multiplexing frame header information of the GRE frames is obtained by inquiring mapping of the GRE frames.

Specific functional modules may be arranged to perform the inquiring mapping. The inquiry may be any one or any combination of the following manners: inquiring mapping of the GRE frames according to key value, inquiring mapping of the GRE frames according to IP address and key value, and inquiring mapping of the GRE frames according to original packet information. The multiplexing frame header information of the GRE frames is obtained by the above inquiring manner. The multiplexing frame header information includes: transmission channel information, key value, and/or outer destination IP address. The GRE frames mentioned above may have two states: already encapsulated using the GRE technique, or already obtaining the corresponding GRE information.

Step 32: Multiplex GRE frames that meet a predetermined multiplexing condition in payloads of one outer IP frame according to the obtained multiplexing frame header information of the GRE frames.

Specifically, in the transmission and bearing of the GRE frames, the GRE frames that meet the predetermined multiplexing condition are set in the payloads of one outer IP frame.

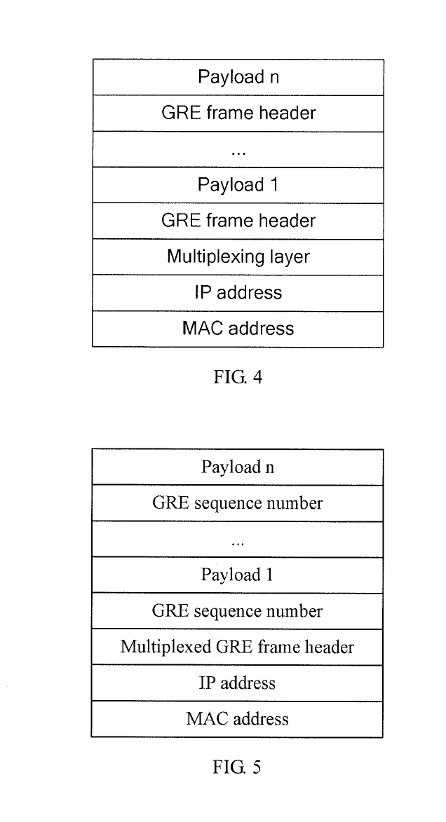

The multiplexing method depends on the predetermined multiplexing condition. Specifically, multiple GRE frames with the same transmission channel and outer destination IP address are set in the payloads of one outer IP frame. FIG. 4 shows the structure of an outer IP frame in which GRE frames are set. Each of the GRE frames in the outer IP frame includes a payload part and a GRE header part. These GRE frames have the same transmission channel and outer destination IP address.

According to different predetermined multiplexing conditions, another multiplexing method may be used. FIG. 5 shows the structure of a GRE frame in which the payloads of multiple GRE frames are set. In FIG. 5, the payloads of GRE frames are set in one GRE frame, and the frame header of the GRE frame is multiplexed; then, the multiplexed GRE frame is set in a payload of one outer IP frame. In this case, the multiplexing condition is that the multiple multiplexing GRE frames have the same key value and outer destination IP address.

In addition, when multiplexing is adopted by the payloads of multiple GRE frames, a GRE sequence number corresponding to respective payloads may be included in the multiplexed GRE frame, and this GRE sequence number is used to indicate the transmission sequence of the GRE frames.

After the corresponding set of multiple GRE frames according to the foregoing technical solution, these GRE frames are encapsulated into the payloads of one outer IP frame, and thus the multiplexing of the frame header the outer IP frame is implemented.

Herein, after multiple GRE frames that meet the multiplexing condition are selected, the frame header of the outer IP frame may be multiplexed according to the preconfigured multiplexing parameter information. That is, the GRE frames that meet the predetermined multiplexing condition and the preconfigured multiplexing parameter information are set in the payloads of one outer IP frame. The preconfigured multiplexing parameter information may include any one or any combination of the following: maximum payload length, maximum multiplexed frame length, or multiplexing waiting time.

The maximum payload length indicates the maximum length of payloads of GRE frames that can adopt multiplexing. This parameter information ensures that long packets exceeding the maximum payload length may not adopt multiplexing. To ensure that the transmission sequence is in order, however, if long packets not requiring multiplexing exist, the multiplexed outer IP frame may also be sent.

The maximum multiplexed frame length indicates the maximum length of the multiplexed outer IP frame. This parameter information is designed to prevent fragments caused by long packets that exceed the maximum multiplexed frame length after being multiplexed.

The multiplexing waiting time is the waiting time before the maximum multiplexed frame length is reached in the multiplexing process. This parameter information is configured to avoid long waiting in the case that the maximum multiplexed frame length is not reached due to too light traffic. That is, when the specified multiplexing waiting time elapses, the multiplexed outer IP frame is sent regardless of whether the maximum multiplexed frame length is reached. In this way, the forwarding efficiency is further improved, and the transmission delay is reduced.

For example, the maximum payload length is set to 100 bits; the maximum multiplexed frame length is set to 200 bits; the multiplexing waiting time is set to 50 ms, and the selected GRE frames meeting the multiplexing condition are GRE frame 1, GRE frame 2, GRE frame 3, and GRE frame 4. If the frame length of GRE frame 1 exceeds 100 bits, namely, the maximum payload length, GRE frame 1 does not require multiplexing but may be directly encapsulated into one outer IP frame for transmission. If the total frame length after the multiplexing of GRE frame 2 and GRE frame 3 is 190 bits, and the total frame length after the multiplexing of GRE frame 4 exceeds 200 bits, namely, the maximum multiplexed frame length is exceeded, because fragments may be caused by long packets at this time, GRE frame 4 cannot adopt multiplexing, and can only wait for the next frame. If the total frame length after the multiplexing of GRE frame 2, GRE frame 3, and GRE frame 4 is 160 bits, and the specified multiplexing waiting time of 50 ms has elapsed, the outer IP frame carrying the multiplexed GRE frame 2, GRE frame 3, and GRE frame is sent to ensure the continuity of transmission. Through the foregoing technical solution, in the transmit bearing of GRE frames, data frames that have small payloads but meet a certain condition can be set together for transmission. Thus, unnecessary encapsulation overheads are reduced, the transmission efficiency of data frames is improved, and network bandwidth resources are effectively saved.

In addition, after the foregoing outer IP frame is sent, if the data receiver receives the outer IP frame, the data receiver needs to demultiplex the outer IP frame to obtain outer IP frames each of which includes a single GRE frame.

For example, if the data receiver receives an multiplexed outer IP frame carrying three GRE frames, it demultiplexes the outer IP frame according to a multiplexing method. Specifically, if the three GRE frames are set in the payloads of one outer IP frame, and the frame header of the outer IP frame is multiplexed, each GRE frame is demultiplexed from the outer IP frame and is separately combined with the multiplexed outer IP frame header to form three independent outer IP frames, each of which includes a single GRE frame, and then the subsequent processing is performed. If the payloads of the three GRE frames are set in one GRE frame, and the frame header of the GRE frame is multiplexed, the payload of each GRE frame is independently demultiplexed and separately combined with the multiplexed GRE frame header, and then independently encapsulated into one outer IP frame to form three independent outer IP frames, each of which includes a single GRE frame, and then the subsequent processing is performed.

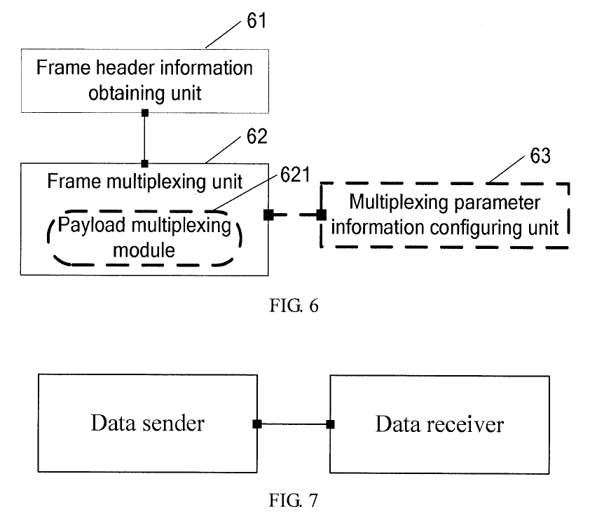

Embodiment 2 provides a GRE bearing apparatus. As shown in FIG. 6, the GRE bearing apparatus includes a frame header information obtaining unit 61 and a frame multiplexing unit 62.

The frame header information obtaining unit 61 is configured to obtain multiplexing frame header information of GRE frames by inquiring mapping of the GRE frames. The multiplexing frame header information includes information about the transmission channel information, key value, and outer destination IP address. The inquiry may be any one or any combination of the following manners: inquiring mapping of the GRE frames according to key value, inquiring mapping of the GRE frames according to IP address and key value, and inquiring mapping of the GRE frames according to original packet information.

The frame multiplexing unit 62 is configured to set GRE frames that meet a predetermined multiplexing condition in payloads of one outer IP frame according to the multiplexing frame header information of the GRE frames that is obtained by the frame header information obtaining unit 61. The specific multiplexing method is already described in the foregoing embodiment.

In addition, the frame multiplexing unit 62 may further include a payload multiplexing module 621, and the payload multiplexing module 621 is configured to set the payloads of GRE frames that meet a predetermined multiplexing condition in one

GRE frame according to the obtained multiplexing frame header information of the GRE frames and multiplex the frame header of the GRE frame.

In addition, the apparatus may further include a multiplexing parameter information configuring unit 63, which is configured to preconfigure multiplexing parameter information. The frame multiplexing unit 62 sets GRE frames that meet the predetermined multiplexing condition in the payloads of one outer IP frame according to the preconfigured multiplexing parameter information. The multiplexing parameter information includes one or more of the following: maximum payload length, maximum multiplexed frame length, or multiplexing waiting time.

The maximum payload length indicates the maximum length of payloads of GRE frames that can adopt multiplexing. The maximum multiplexed frame length indicates the maximum length of a multiplexed outer IP frame. The multiplexing waiting time is the waiting time before the maximum multiplexed frame length is reached in the multiplexing process.

The foregoing apparatus may be integrated in a data sender and may also be an independent functional entity.

Embodiment 3 of the present invention provides a GRE bearing system. As shown in FIG. 7, the GRE bearing system includes a data sender and a data receiver.

The data sender is configured to obtain multiplexing frame header information of GRE frames by inquiring mapping of the GRE frames and set GRE frames that meet a predetermined multiplexing condition in payloads of one outer IP frame according to the obtained multiplexing frame header information of the GRE frames.

The data receiver is configured to demultiplex the multiplexed outer IP frame after receiving the outer IP frame to obtain multiple IP frames, each of which includes a single GRE frame.

In addition, the foregoing data sender may set the payloads of GRE frames that meet the predetermined multiplexing condition in one GRE frame and multiplex the frame header of the same GRE frame.

The inquiry may be any one or any combination of the following manners: inquiring mapping of the GRE frames according to key value, inquiring mapping of the GRE frames according to IP address and key value, and inquiring mapping of the GRE frames according to original packet information.

In the foregoing apparatus and system embodiments, the included units are defined according to the function logic only, and the present invention is not limited to such definitions so long as the corresponding functions can be implemented. Furthermore, the specific names of the functional units are given for the purpose of differentiating each other only, and not intended to limit the scope of the present invention.

It is understandable to those skilled in the art that all or part of the steps of the foregoing embodiments may be implemented by hardware instructed by a program. The program may be stored in a computer-readable storage medium. When being executed, the program performs the following steps:
obtaining multiplexing frame header information of GRE frames by inquiring mapping of the GRE frames; and
setting GRE frames that meet a predetermined multiplexing condition in payloads of one outer Internet Protocol (IP) frame according to obtained multiplexing frame header information of the GRE frames.

The storage media may be a Read Only Memory (ROM), a magnetic disk, or a Compact Disk-Read Only Memory (CD-ROM).

In conclusion, in the transmission and bearing of GRE frames, the embodiments of the present invention combine the data frames that have small payloads together for transmission and bearing, and thus unnecessary encapsulation overheads are reduced. Therefore, the embodiments of the present invention can improve the transmission efficiency of data frames. Thus, network bandwidth resources are saved, and the system transmission performance is improved.

Although the invention has been described through some exemplary embodiments, the invention is not limited to such embodiments. It is apparent that those skilled in the art can make various variations and substitutions to the invention without departing from the spirit and scope of the invention. The invention is intended to cover the variations and substitutions provided that they fall within the scope of protection defined by the claims or their equivalents.

What is claimed is:

1. A Generic Routing Encapsulation (GRE)bearing method, comprising:
obtaining multiplexing frame header information of GRE frames by inquiring mapping of the GRE frames; and
setting GRE frames that meet a predetermined multiplexing condition in payloads of one outer Internet Protocol (IP)frame according to obtained multiplexing frame header information of the GRE frames.

2. The method of claim 1, wherein the predetermined multiplexing condition comprises:
the GRE frames having a same transmission channel and a same outer destination IP address.

3. The method of claim 2, wherein each of the GRE frame set in payloads of one outer Internet Protocol (IP) frame comprises a payload part and a GRE header part.

4. The method of claim 1, wherein the step of setting the GRE frames that meet the predetermined multiplexing condition in the payloads of one outer IP frame further comprises:
setting payloads of the GRE frames that meet the predetermined multiplexing condition in one GRE frame and multiplexing a frame header of the one GRE frame; and
setting the multiplexed GRE frame in a payload of one outer IP frame.

5. The method of claim 4, wherein the predetermined multiplexing condition comprises:
the GRE frames having a same key value and a same outer destination IP address.

6. The method of claim 5, wherein the GRE frame further comprises a GRE sequence number corresponding to the payload of the GRE frame.

7. The method of claim 1, wherein:
the multiplexing frame header information of the GRE frames comprises: a transmission channel information a key value, and an outer destination IP address.

8. The method of claim 1, wherein the inquiring mapping of the GRE frames comprises any one or any combination of the following:
inquiring mapping of the GRE frames according to key value, inquiring mapping of the GRE frames according to IP address and key value, and inquiring mapping of the GRE frames according to original packet information.

9. The method of claim 1, wherein the step of setting the GRE frames that meet the predetermined multiplexing condition in the payloads of one outer IP frame according to the obtained multiplexing frame header information of the GRE frames further comprises:
setting the GRE frames that meet the predetermined multiplexing condition in the payloads of one outer IP frame according to preconfigured multiplexing parameter information and the obtained multiplexed frame header information of the GRE frames.

10. The method of claim 9, wherein the preconfigured multiplexing parameter information comprises any one or any combination of the following: maximum payload length, maximum multiplexed frame length, and multiplexing waiting time.

11. A demultiplexing method, comprising:
receiving an outer Internet Protocol (IP)frame, wherein Generic Routing Encapsulation (GRE)frames that meet a predetermined multiplexing condition are set in payloads of the outer IP frame according to multiplexing frame header information of the GRE frames; and
demultiplexing the outer IP frame according to different multiplexing manners to obtain multiple IP frames, each of which comprises a single GRE frame.

12. The method according to claim 11, wherein if a frame header of the outer IP frame is multiplexed, the step of demultiplexing further comprises:
demultiplexing the outer IP frame to obtain each GRE frame of the GRE frames;
combining the each GRE frame with the multiplexed outer IP frame header to form independent outer IP frames separately.

13. The method according to claim 11, wherein if payloads of the GRE frames are set in one GRE frame, and the frame header of the one GRE frame is multiplexed, the step of demultiplexing further comprises:
demultiplexing to obtain payload of each GRE frame of the GRE frames independently;
combining the each frame with the multiplexed GRE frame header; and
encapsulating the each frame after combining into the outer IP frame independently to form independent outer IP frames.

14. A Generic Routing Encapsulation(GRE) bearing apparatus, comprising:
a frame header information obtaining unit, configured to obtain multiplexing frame header information of GRE frames by inquiring mapping of the GRE frames; and
a frame multiplexing unit, configured to set GRE frames that meet a predetermined multiplexing condition in payloads of one outer Internet Protocol (IP) frame according to the multiplexing frame header information of the GRE frames that is obtained by the frame header information obtaining unit.

15. The apparatus of claim 14, wherein the frame multiplexing unit further comprises:
a payload multiplexing module, configured to set payloads of the GRE frames that meet the predetermined multiplexing condition in one GRE frame according to the multiplexing frame header information of the GRE frames that is obtained by the frame header information obtaining unit and multiplex a frame header of the GRE frame.

16. The apparatus of claim 14, further comprising a multiplexing parameter information configuring unit, wherein:
the multiplexing parameter information configuring unit is configured to preconfigure multiplexing parameter information, and the frame multiplexing unit set the GRE frames that meet the predetermined multiplexing condition in the payloads of one outer IP frame according to the preconfigured multiplexing parameter information; and
the multiplexing parameter information comprises any one or any combination of the following: maximum payload length, maximum multiplexed frame length, or multiplexing waiting time.
